(19) United States
(12) Patent Application Publication
(10) Pub. No.: US 2019/0012700 A1
(43) Pub. Date: Jan. 10, 2019

(54) SYSTEMS AND METHODS FOR COOKIELESS CONVERSION MEASUREMENT OF ONLINE DIGITAL ADVERTISING

(71) Applicants: Sathyender NELAKONDA, Saratoga, CA (US); Nikhil MISHRA, Sunnyvale, CA (US); Alexey D. ZININ, Cupertino, CA (US); Pradeep SINGH, Cupertino, CA (US); William J. LEECE, San Jose, CA (US)

(72) Inventors: Sathyender NELAKONDA, Saratoga, CA (US); Nikhil MISHRA, Sunnyvale, CA (US); Alexey D. ZININ, Cupertino, CA (US); Pradeep SINGH, Cupertino, CA (US); William J. LEECE, San Jose, CA (US)

(21) Appl. No.: 15/642,124

(22) Filed: Jul. 5, 2017

(51) Int. Cl. G06Q 30/02; H04L 29/08; H04L 29/06

(52) U.S. Cl. CPC G06Q 30/0246; G06Q 30/0277; H04L 67/02; H04L 69/22; H04L 67/22

(57) ABSTRACT

Systems, methods and computer program products for measuring conversion in online digital advertising solve different technical challenges in measuring digital advertising conversion across browsers, applications, domains and devices without deploying cookies.

### CROSS REFERENCE TO RELATED APPLICATIONS

This application is related to U.S. Published Application No. 2015/0019721, filed on Jul. 11, 2014, and entitled “Method And System For Correlation Of Internet Application Domain Identities And Network Device Identifiers,” which claims priority to and the benefit of U.S. Provisional Patent Application No. 61/845,331, filed on Jul. 11, 2013, and entitled “Method And System For Correlation Of Internet Application Domain Identities And Network Device Identifiers.” This application is also related to U.S. application Ser. No. 15/486,214, filed on Apr. 12, 2017, and entitled “Systems And Methods For Relevant Targeting Of Online Digital Advertising,” and U.S. application Ser. No. 15/480,243, filed on Apr. 5, 2017, and entitled “Systems And Methods For Cookieless Opt-Out Of Device Specific Targeting.”

### INCORPORATION BY REFERENCE

All publications and patent applications mentioned in this specification are incorporated herein by reference in their entirety to the same extent as if each individual publication or patent application was specifically and individually indicated to be incorporated by reference.

### BACKGROUND

### Field of Innovation

This disclosure is in the field of online digital advertising. It generally relates to tracking conversion events that helps advertisers effectively measure performance of advertising campaigns. More specifically, this disclosure relates to cookie-less conversion measurement using network operator infrastructure.

### Description of the Related Art

In the field of online digital advertising, conversion events are valuable assets to be tracked for Advertisers. The tracking of conversion events helps determine how successful the advertising is working where success is measured as return on ad spend. A conversion event in online advertising is defined as a specific action by a consumer measured as success by an advertiser that can be attributed to advertising exposure, such as viewing the advertisement or clicking on it. This specific action can be anything from a user who first sees an online advertisement then views the advertised product or service online on the advertiser's domain or other retail site, adds the product to a checkout cart or list, submits an application, sends a query, signs up for a newsletter, or actually purchases the advertised product or service. Being able to measure such actions is highly beneficial for advertisers as it enables them to not only measure the success of their advertising campaigns but to also help target consumers effectively in the future based on specific action

Typically, conversion measurement workflow starts with serving an advertisement to a user. Ads are served to users on various domains which may or may not be owned by the advertisers. Ads may be viewed on a user's device and the user may take specific action(s) in response to viewing the ad. After viewing an ad, a user can visit an advertiser's domain organically by navigating to the domain on their own, or inorganically by clicking on a link embedded in the ad. Advertisers can define multiple conversion events as outlined above. Conversion pixels are embedded on each page of the advertiser's domain. The conversion pixels fire when a user visits this page on a browser or app. Since the conversion pixel may be fired at a different time and domain than where the ad was served to user, the challenge for advertisers is to be able to correlate these two disparate sets of events, i.e. a user viewing or clicking on an ad to finally taking the specific action that is counted as a conversion event. Most platforms today use cookie-based methods for such correlation, wherein the advertising platform stores the state of the user on the client side using cookies. Cookie based methods for correlations do not work in scenarios such as cookie expiry, users in private browsing mode, from within mobile applications, across different browsers, or across different devices used by the same user. Additionally, cookies come with a traditional set of problems including overloading the browsers, consuming memory on devices, etc. The inability of cookies to be persistent hinders advertisers from being able to correlate a user's actions to the advertiser's source ad.

In light of the above challenges, what is needed and is not provided by the prior art are systems and methods that measure online advertisement conversion events across browsers, applications and devices, or when cookies have been disabled.

### SUMMARY OF THE DISCLOSURE

Systems, methods and computer program products for measuring conversion in online digital advertising are disclosed herein. Various aspects of this disclosure solve different technical challenges in measuring digital advertising conversion across browsers, applications, domains and devices without deploying cookies.

According to aspects of the disclosure, methods for measuring conversion in online digital advertising are provided. In some embodiments, the methods comprise facilitating the serving of an advertisement to a first client device, and sending a source event indicator from the first client device to an event mapping server after a predetermined source event associated with the advertisement has occurred on the first client device. The source event indicator is then stored on the event mapping server along with a unique device identifier associated with the first client device. In response to detecting a conversion event, a conversion event indicator is sent to the event mapping server along with the unique device identifier. The source event is then correlated with the conversion event using the unique device identifier. During this process, no cookies need be placed on the client device.

In some embodiments, the detecting a conversion event step comprises examining an HTTP header. An IP address, private or public may be read from the HTTP header during the process. In some embodiments, the IP address is used as the unique device identifier.

In some embodiments, the conversion event is selected from the group consisting of viewing an advertised product or service online, adding the product or service to a checkout cart or list, submitting an application, sending a query, or purchasing the advertised product or service. The conversion event indicator may be sent from the first client device to the event mapping server, or it may be sent from a second client device. The source event may occur on a first browser while the conversion event occurs on the first browser or a second browser and/or app or a different device altogether. The source event may occur on a first mobile application while the conversion event occurs on a first or second mobile application or browser. The source event may occur on a first domain while the conversion event occurs on a second domain.

In some embodiments, the method further comprises sending information about the conversion event to an entity that provided the advertisement. Steps may then be taken to not target and serve particular advertisements to the user of the first device based on the information about the conversion event. Steps may be taken to serve retargeted advertising based on the specific action measured from consumers. Steps may be taken to serve advertising for complimentary products by the advertiser.

According to other aspects of the disclosure, systems for measuring conversion in online digital advertising are provided. In some embodiments, the systems comprise at least one processor configured to facilitate the serving of an advertisement to a first client device, and the sending of a source event indicator from the first client device to an event mapping server after a predetermined source event associated with the advertisement has occurred on the first client device. The at least one processor is further configured to store the source event indicator on the event mapping server along with a unique device identifier associated with the first client device. A conversion event indicator is sent to the event mapping server along with the unique device identifier in response to detecting a conversion event. The source event is then correlated with the conversion event using the unique device identifier. The systems also comprise a memory coupled to the at least one processor and configured to provide the at least one processor with instructions.

According to further aspects of the disclosure, a computer program product for measuring conversion in online digital advertising is provided. The computer program product is embodied in a non-transitory computer readable storage medium and comprises computer instructions for carrying out one or more of the previously described methods.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a diagram depicting an exemplary system architecture for online ad conversion measurement according to aspects of the disclosure; and

FIG. 2 is a flowchart depicting an example method for online ad conversion measurement according to aspects of the disclosure.

FIG. 3 is a data flow diagram depicting an example method for cookieless online ad conversion measurement and visualization

FIG. 4 is a sequence diagram depicting an example of how business rules are applied for conversion event attribution to source events (ad view or click)

### DETAILED DESCRIPTION

The present disclosure is illustrated by way of example and not by way of limitation in accompanying drawings in which like references indicate similar elements. It should be noted that references to “an” or “one” or “some” embodiment(s) in this disclosure are not necessarily to the same embodiment, and such references mean at least one.

Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and multiple hosts can be connected by one or more networks.

As used herein, the terms “engine” and “server” may refer to software, firmware, hardware, or any other component that is used to effectuate a purpose. The engine or server may include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program may include calls to hardware components (such as input/output (I/O) devices), which may require the execution of drivers. The drivers may or may not be considered part of the engine or server.

As used herein, the term “database” is used broadly to include any known or convenient means for storing data, whether centralized or distributed, relational or otherwise.

As used herein, the term “mobile device” may be, but is not limited to, a cell phone, such as an Apple iPhone, a portable electronic device, such as an Apple iPod Touch, Apple iPad, Microsoft Surface, and a mobile device based on the Google Android operating system, a smart watch, smart glasses, and any other portable electronic device that includes software, firmware, hardware, or a combination thereof that is capable of providing the functionality described herein. Typical components of the mobile device may include, but are not limited to, persistent memories like flash read-only memory (ROM), random access memory like static random-access memory (SRAM), a camera, a battery, liquid crystal display (LCD) driver, a display, a cellular antenna, a speaker, a Bluetooth circuit, and Wi-Fi circuitry, where the persistent memory may contain programs, applications, and/or an operating system for the mobile device.

As used herein, the term computer can be but is not limited to, a personal computer or a laptop, such as a Hewlett-Packard Pavilion desktop computer, Dell Ultrabook laptop, Apple MacBook laptop, or other electronic device based on an operating system such as Microsoft Windows or Apple OS X, and any other electronic device that includes software, firmware, hardware, or a combination thereof that is capable of providing the functionality described herein. Typical components of the computer may include but are not limited to persistent memories like flash ROM, random access memory like SRAM, a battery, a hard-disk or solid-state drive, a display adapter, a network controller used for connecting to a fixed-line network, a speaker, a Bluetooth circuit, and Wi-Fi circuitry, where the persistent memory may contain programs, applications, and/or an operating system for the computer.

Various implementations of the systems described herein can use appropriate hardware or software; for example, certain components can execute on server class computers that have sufficient memory, data storage, and processing power and that run a server class operating system (e.g., Oracle® Solaris®, GNU/Linux®, and the Microsoft® Windows® family of operating systems) or other hardware (e.g., mobile devices, computers, etc.) capable of running an operating system such as the Microsoft Windows® operating systems, the Apple OS X® operating systems, the Apple iOS® platform, the Google Android™ platform, the Linux® operating system and other variants of UNIX® operating systems, and the like. The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

In various implementations, the devices include a web browser, client software, or both. The web browser allows the device to request a web page or other downloadable program, applet, or document (e.g., from a server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the device manually requests a web page from the server. Alternatively, the device automatically makes requests with the web browser. Examples of commercially available web browser software are Microsoft® Internet Explorer®, Mozilla® Firefox®, Apple® Safari® and Google Chrome®

In some implementations, the devices include client software. The client software provides functionality to the device that provides for the implementation and execution of the features described herein. The client software can be implemented in various forms, for example, it can be in the form of a web page, widget, and/or Java, JavaScript (JS), .Net, Silverlight, Flash, and/or other applet or plug-in that is downloaded to the device and runs in conjunction with the web browser. The client software and the web browser can be part of a single client-server interface; for example, the client software can be implemented as a “plug-in” to the web browser or to another framework or operating system. Any other suitable client software architecture, including but not limited to widget frameworks and applet technology can also be employed with the client software.

Communication among servers, computers, mobile devices, and other components can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are contemplated. The network can carry TCP/IP protocol communications, and HTTP/HTTPS requests made by a web browser, and the connection between the user devices and servers can be communicated over such TCP/IP networks. Other communication protocols are contemplated.

Method steps of the techniques described herein can be performed by one or more programmable processors executing one or more computer programs to perform functions by operating on input data and generating output. Method steps can also be performed by, and the modules can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store instructions that, when executed by a processor, form the modules and other components described herein and perform the functionality associated with the components. The processor and the memory can be supplemented by, or incorporated in special purpose logic circuitry.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

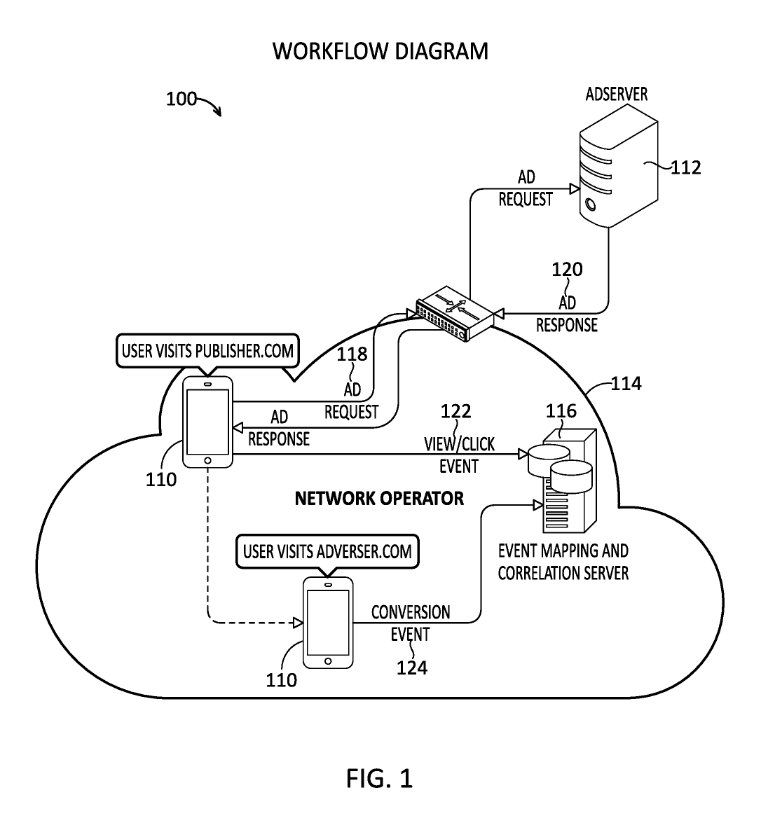

Referring to FIG. 1, an exemplary embodiment of a system 100 configured according to aspects of the disclosure is shown. Various aspects of this system solve different technical challenges in measuring digital advertising conversion across browsers, applications and devices without deploying cookies.

While browsing web pages on the internet, a user typically visits various web pages that have been integrated with advertising platforms, such as ad exchanges, ad networks, supply side platforms (SSPs), direct marketplace or private marketplace, demand side platforms (DSPs) and the like, for serving ads from various advertisers. An ad is served to a user or client device 110 from an ad server 112. In conventional advertising systems, at the time of ad serving the user is identified by an ID from advertising platforms. More often than not, this ID is conventionally stored as cookies in the user's browser. As previously mentioned in the Background section above, advertisers are interested in measuring actions taken by this user after viewing or clicking on this creative. Actions are typically defined by the advertiser. For example, after viewing the ad, the user made a purchase on the advertiser's web site. At the time of action, the advertiser typically synchronizes this information with the advertising platforms. The challenge is to be able to correlate this action to the same user who has seen ad. As previously described, problems emerge when cookies are used in such implementation to measure such conversions. Cookies do not work for applications running on a mobile device, if the user has disabled third party cookies, if the user has moved to a different browser, or if the user has changed devices altogether. In conventional systems, the inability of cookies to be persistent hinders advertisers from being able to correlate the conversion actions to their source ads.

According to one aspect of the present disclosure, advertisers are able to measure conversions without deploying cookies. Instead of using cookies, the systems and methods of the present disclosure use network operator infrastructure to track and measure conversion events.

Users depend on network providers for accessing the internet. Typically, a user authenticates with a provider of a network 114 using various authentication mechanisms and gets assigned an IP address that is unique for every user. All traffic from this user flows with this signature IP address or identifier as assigned by the provider of network 114. The network provider maintains a mapping of each user's details associated with the user's IP identifier in the provider's infrastructure. This allows only authenticated subscribers/users to access the network using the network provider's infrastructure.

According to aspects of the disclosure, when an ad is served to a user the network operator stores this event in an event mapping and correlation server 116 to be tracked later for conversion. This event may be stored in a map table using a one way hash of the user's device IP identifier as a key. At the time the user takes action, such as on the advertiser's domain site or mobile app, an HTTP request can be sent to the network provider. Since all HTTP requests carry a unique IP identifier assigned to the user, the network provider first looks up the user device using the IP identifier in the request. Using the one way hash of the user device ID, the network provider can now map this action to its source ad that was served to the user.

More specifically, as depicted in FIG. 1, an ad conversion tracking process according to the present disclosure may start with an ad request 118 being sent from user device 110 to ad server 112. Ad server 112 responds to ad request 118 by serving ad 120 to user device 110. Once a predetermined source event occurs, such as the user viewing or clicking on the ad, a source event indicator 122 is sent from user device 110 to the event mapping server 116. The source event indicator 122 is stored on the event mapping server 116 along with the previously described unique device identifier.

If the user subsequently engages in a conversion event, such as viewing the advertised product or service online on the advertiser's domain or other retail site, adding the product to a checkout cart or list, submitting an application, sending a query, or actually purchasing the advertised product or service, this conversion event is detected and a conversion event indicator 124 is sent from device 110 to event mapping server 116 along with the unique device identifier. For example, if the user visits the advertiser's domain, a conversion pixel is fired. Conversion pixels are typically HTTP requests, which when intercepted from inside the carrier's network 114 get private IP assigned to the device by the carrier.

The carrier can host a private IP to depersonalized subscriber ID map table for all devices on a carrier's network 114. The carrier can look up private IP in the map table and map it to the depersonalized subscriber ID. This ID can now be used to look up in the interim cache and mark conversion for the user based on business rules defined by the advertisers.

Based on the same device identifier being used in the source event indicator 122 and the conversion event indicator 124, event mapping server 116 may now correlate the source event with the conversion event. This tracked correlation may then be aggregated with other similarly tracked events to measure the number of conversion events that were produced by a particular ad campaign. The aggregated conversion results may then be supplied to the advertiser and/or other entities in the advertising chain, as payments from the advertiser may be conditioned on the number and/or type of conversion events that have occurred.

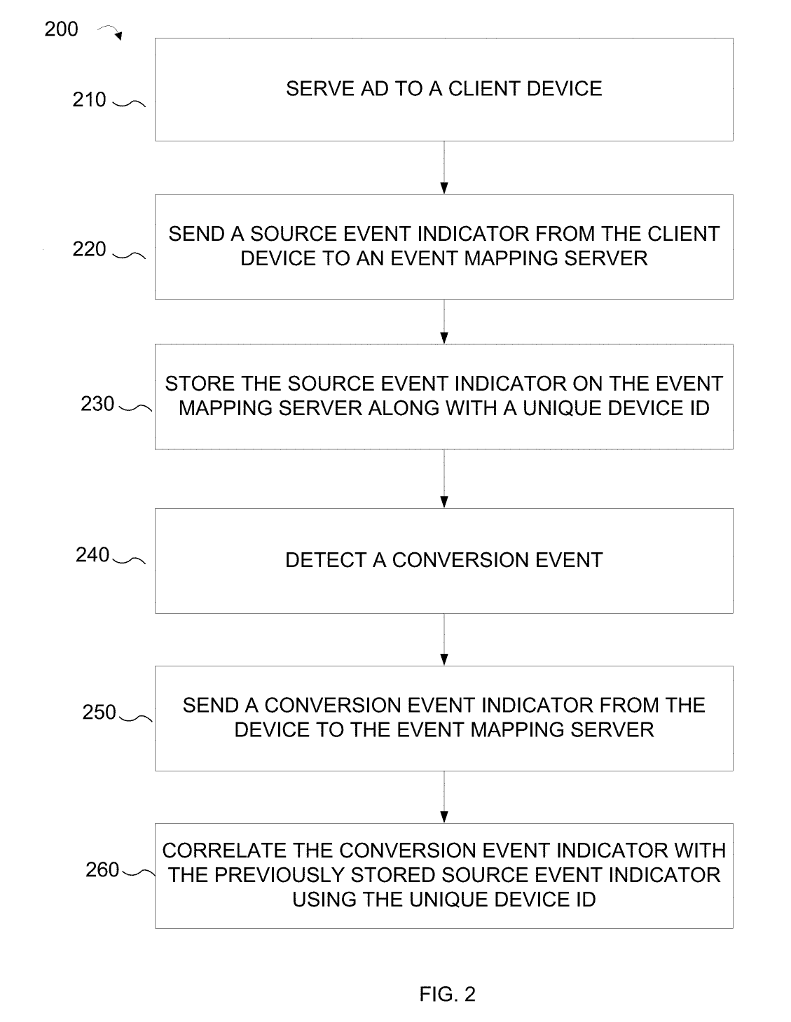

Referring now to FIG. 2, exemplary steps for a cookie-less ad conversion tracking method 200 associated with system 100 of FIG. 1 are provided. As shown in step 210, an advertisement is served to a user or client device. Once a predetermined source event occurs, such as the user viewing or clicking on the ad, a source event indicator is sent from the client device to an event mapping server, as shown in step 220. In step 230, the source event indicator is stored on the event mapping server along with a unique device identifier, as previously described. If the device user engages in a conversion event, the next step 240 is to detect this event. Once a conversion event is detected, a conversion event indicator is sent from the client device to the event mapping server along with the unique device identifier, as shown by step 250. Upon receiving the conversion event indicator from the client device, in step 260 the unique device identifier is used to correlate the conversion event with the previously stored source event.

In some embodiments the unique device identifier that is sent from the client device and or stored on the event mapping server is an IP address assigned to the device or user. In other embodiments, the unique device identifier is another identifier associated with the device, user or account with the network provider. For example, the identifier that is actually stored might be a network-level device identifier such as a Media Access Control (MAC) address, International Mobile Subscriber Identity (IMSI), International Mobile Station Equipment Identity (IMEI), subscriber account number, phone number, or other depersonalized subscriber ID assigned by the carrier to each subscriber on their network.

The disclosed systems and methods take advantage of a network provider's infrastructure to identify all users uniquely and enable an advertiser to measure conversion across different browsers, different mobile applications, different domains, and combinations thereof seamlessly. All http requests from user's device whether through browsers or apps contain unique IP assigned to the user by a network provider. This unique IP can be used to map a user's actions across applications without deploying cookies.

The disclosed systems and methods also enable advertisers to measure conversion across different devices that are registered to the same user within a given carrier. Since all devices owned by a user are authenticated with network providers to access the internet, network providers typically assign unique IP or a set of IPs to each of these devices, all of which are mapped to the same user and can be used to track conversion events.

Ultimately, effective conversion measurement and correlation can be useful for advertisers and technology platforms in the following ways in online advertising systems:
1. Advertisers can measure performance of each of their targeting campaigns with user centric approach instead of being browser based or specific application based;
2. Advertisers can apply this information to target users effectively;
3. Advertisers can apply this information to not target and serve ads to a user after a conversion event has occurred for a particular product line;
4. Advertisers can apply this information to not target and serve ads to a user after a conversion event has occurred for other similar product lines; and
5. Advertisers can apply this information to build look-alike segments and effectively target other users that have shown similar actionable behavior.

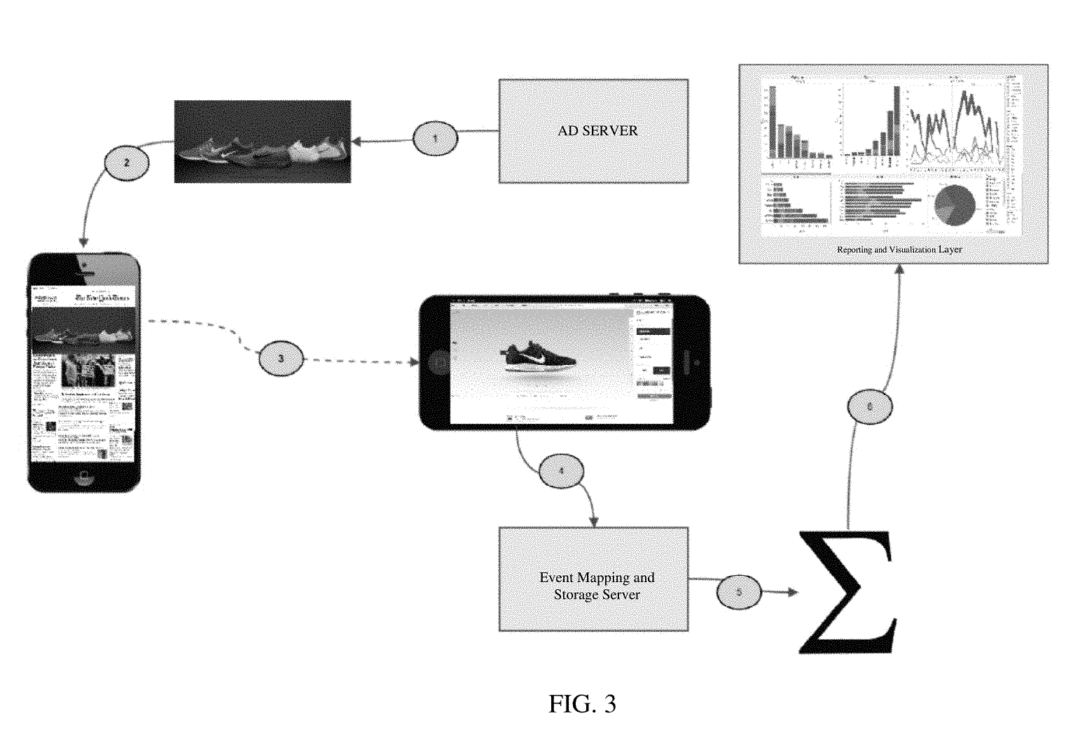

Referring to FIG. 3, a data flow diagram depicting an example method for cookieless online ad conversion measurement and visualization is shown. In Step 1 of the exemplary method, an ad is served from an ad sever as previously described. In Step 2, the ad displays on a consumer's mobile phone. Either immediately or after the passage of some time, in Step 3 the consumer visits the advertiser's website and ultimately purchases a product from the website. There are at least two distinct routes to an advertiser website that the consumer may take after seeing an ad. First, the consumer may simply visit the site ‘organically’ by, for example, typing www.nike.com in their browser. Second, they may click on the ad and land on the advertisers landing page. In either instance, the ad will be given credit for any conversion event that occurs within a pre-specified amount of time. Note also that a conversion event does not necessarily have to be a purchase. It could be, for example, signing up for a newsletter or submitting an email address, etc. This is known as a “lead”.

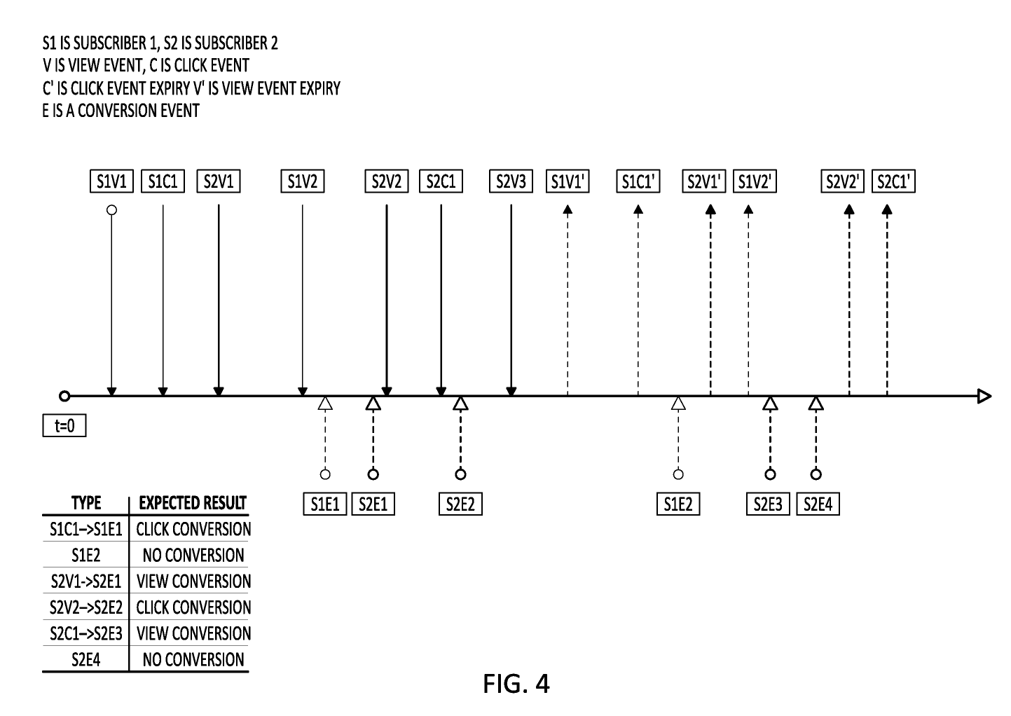

After completing the purchase in Step 3 above, a conversion pixel fires in Step 4, which causes a redirect to a pixel server and then to an event mapping and storage server on the operator's network, where the consumer's device ID is looked up, along with other relevant information that may exist. The device ID is looked up to provide attribution (e.g. to see if this user has seen an ad from the advertiser or brand in context.) In Step 5, the conversion event is then attributed to the previous source event. In some implementations of the system, two different types of conversion events are tracked. The first is a view based event, where the user views the ad and then performs the conversion event. The second is a click based event, where the user clicks on the ad and then performs the conversion event. Exemplary business rules for attribution are subsequently described in relation to FIG. 4.

In Step 6, conversion statistics are aggregated after the click validity window aggregation period passes. In some implementations of the system the click validity window is two hours long, meaning that if the user does not click on an ad within two hours of it being served to his device, attribution is no longer available for this ad. In some implementations, the conversion statistics are aggregated with hour granularity. Current impression and click statistics are also aggregated. These aggregate statistics are pushed to a web portal for inclusion in ad campaign performance reports, as depicted in FIG. 3.

Referring to FIG. 4, a sequence diagram is shown depicting an example of how business rules may be applied for conversion event attribution to source events, wherein:

S1 is Subscriber 1

S2 is Subscriber 2

V is a view event

C is a click event

C′ is a click event expiry

V′ is a view event expiry

e is a conversion event

The first arrow on the timeline of FIG. 4 labeled “S1V1” therefore denotes a first view event by Subscriber 1. Arrows above the timeline pointing down denote view or click events, and arrows above the timeline pointing up (also dashed) denote view or click event expiries. Arrows below the timeline pointing up (also dashed) denote conversion events.

The following connected events can be seen in FIG. 4:
S1C1→S1E1: Subscriber 1 clicks on the Ad then followed by conversion event resulting in attributed conversion.
S1E2: No attributed conversion as there were no preceding unattributed Ad events
S2V1→S2E1: Subscriber 2 views the Ad then followed by conversion event resulting in attributed conversion
S2V2→S2E2: Subscriber 2 views Ad then followed by conversion event resulting in attributed conversion
S2C1→S2E3: Subscriber 2 clicks on the Ad then followed by conversion event resulting in attributed conversion.
S2E4: No valid conversion as there were no preceding unattributed Ad event.

It should be noted that not every conversion event results counts as an attributed conversion. For example, S1E2 has no attributed conversion as there were no preceding unattributed ad events that can be considered the source of the conversion event. In particular, S1V2 does not count as the source for S1E2 since it occurred prior to S1E1. Similarly, S2E4 has no attributed conversion as there were no preceding unattributed ad events that can be considered the source of the conversion event. In particular, S2V3 does not count as the source for S2E4 since it occurred prior to S2E3. It should also be noted that if a conversion event (not shown) had a preceding unattributed Ad event as its source, but occurred after the expiry of the preceding unattributed event, the conversion event would not result in attributed conversion.

It should be noted that the solutions disclosed herein are designed with very strong considerations for users' privacy in mind. Since private IP identifiers and depersonalized subscriber IDs are not based on personally identifiable information (PII) and the map table is only internal to the carrier, user's privacy remains fully intact.

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A method for measuring conversion in online digital advertising, comprising:
facilitating the serving of an advertisement to a first client device;
sending a source event indicator from the first client device to an event mapping server after a predetermined source event associated with the advertisement has occurred on the first client device;
storing the source event indicator on the event mapping server along with a unique device identifier associated with the first client device;
detecting a conversion event;
sending a conversion event indicator to the event mapping server along with the unique device identifier in response to detecting the conversion event; and
correlating the source event with the conversion event using the unique device identifier.

2. The method of claim 1, wherein no cookies are placed on the client device by the method.

3. The method of claim 1, wherein the detecting a conversion event step comprises examining an HTTP header.

4. The method of claim 3, wherein an IP address is read from the HTTP header.

5. The method of claim 4, wherein the IP address is used as the unique device identifier.

6. The method of claim 1, wherein the conversion event is selected from the group consisting of viewing an advertised product or service online, adding the product or service to a checkout cart or list, submitting an application, sending a query, or purchasing the advertised product or service.

7. The method of claim 1, wherein the conversion event indicator is sent from the first client device to the event mapping server.

8. The method of claim 1, wherein the conversion event indicator is sent from a second client device to the event mapping server.

9. The method of claim 1, wherein the source event occurs on a first browser and the conversion event occurs on a second browser.

10. The method of claim 1, wherein the source event occurs on a first browser and the conversion event occurs in a mobile application

11. The method of claim 1, wherein the source event occurs on a first mobile application and the conversion event occurs on a second mobile application.

12. The method of claim 1, wherein the source event occurs on a first mobile application and the conversion events occurs on a browser

13. The method of claim 1, wherein the source event occurs on a first domain and the conversion event occurs on a second domain.

14. The method of claim 1, further comprising sending information about the conversion event to an entity that provided the advertisement.

15. The method of claim 12, further comprising taking steps to not target and serve particular advertisements to the user of the first device based on the information about the conversion event.

16. A system for measuring conversion in online digital advertising, comprising:
at least one processor configured to:
facilitate the serving of an advertisement to a first client device;
send a source event indicator from the first client device to an event mapping server after a predetermined source event associated with the advertisement has occurred on the first client device;
store the source event indicator on the event mapping server along with a unique device identifier associated with the first client device;
detect a conversion event;
send a conversion event indicator to the event mapping server along with the unique device identifier in response to detecting the conversion event; and
correlate the source event with the conversion event using the unique device identifier; and
a memory coupled to the at least one processor and configured to provide the at least one processor with instructions.

17. A computer program product for measuring conversion in online digital advertising, the computer program product being embodied in a non-transitory computer readable storage medium and comprising computer instructions for:
facilitating the serving of an advertisement to a first client device;
sending a source event indicator from the first client device to an event mapping server after a predetermined source event associated with the advertisement has occurred on the first client device;
storing the source event indicator on the event mapping server along with a unique device identifier associated with the first client device;
detecting a conversion event;
sending a conversion event indicator to the event mapping server along with the unique device identifier in response to detecting the conversion event; and
correlating the source event with the conversion event using the unique device identifier.
